(19) United States
(12) Patent Application Publication
(10) Pub. No.: US 2013/0145013 A1
(43) Pub. Date: Jun. 6, 2013

(54) COMMUNICATION TERMINAL AND CONTENT UPDATE METHOD

(71) Applicants: Keiichi Murakami, Chiyoda-ku (JP); Taeko Yamaki, Chiyoda-ku (JP)

(72) Inventors: Keiichi Murakami, Chiyoda-ku (JP); Taeko Yamaki, Chiyoda-ku (JP)

(73) Assignee: NTT DOCOMO, INC., Tokyo (JP)

(21) Appl. No.: 13/816,849

(22) PCT Filed: May 29, 2012
(86) PCT No.: PCT/JP2012/063776

§ 371 Date: Feb. 13, 2013

(30) Foreign Application Priority Data
Jun. 13, 2011 (JP) 2011-131248

(51) Int. Cl. H04L 12/24

(52) U.S. Cl. CPC H04L 41/00
USPC 709/223

(57) ABSTRACT

A communication terminal and a content update method in a communication terminal that can update content at the optimum time according to the content type, the communication terminal includes a content storage unit that stores content containing first time information indicating the maximum time unit of information representing a time, a terminal information storage unit that stores terminal information containing second time information indicating a time unit shorter than the maximum time unit and assigned to each communication terminal, a time determination unit that determines whether it has reached a time consisting of the first and the second time information, and a content update unit that updates content when the time determination unit determines that it has reached a time consisting of the first and the second time information, thereby delivering content at the optimum time according to the content type.

### TECHNICAL FIELD

The present invention relates to a communication terminal that receives content and a content update method.

### BACKGROUND ART

Access to information content on the Internet using a mobile communication terminal such as a mobile phone has become widespread, and push type services where update information of news, weather and the like are delivered from information providers to mobile communication terminals are widely used.

As this kind of technique, the following content delivery system is disclosed in Patent Literature 1. A content delivery server generates download time information based on random numbers within the range of a specified period of time. A user terminal obtains the download time information generated by the content delivery server and executes downloading of content data from the content delivery server in accordance with the time indicated by the download time information.

### CITATION LIST

### Patent Literature

Patent Literature 1: Japanese Unexamined Patent Application Publication No. 2006-18506

### SUMMARY OF INVENTION

### Technical Problem

However, in the above-described related art, content cannot be updated at the optimum time according to the type of content. For example, weather forecast content is updated based on information that is released at the fixed time everyday by the meteorological agency or the like. Thus, if the update of weather forecast content is performed in a terminal immediately after the time when information is released by the meteorological agency or the like, the information released by the meteorological agency or the like can be reflected on the content right away. In this manner, it is desirable to update content at the optimum time according to the type of content.

The present invention has been accomplished to solve the above problems and an object of the present invention is thus to provide a communication terminal and a content update method in a communication terminal that can update content at the optimum time according to the type of content.

### Solution to Problem

To solve the above problem, a communication terminal according to the present invention includes a content storage means for storing content containing first time information indicating a specified time unit of information representing a time, a terminal information storage means for storing terminal information containing second time information indicating a time unit shorter than the specified time unit and assigned to each communication terminal, a time determination means for determining whether it has reached a time consisting of the first time information and the second time information, and a content update means for performing a content update process when the time determination means determines that it has reached a time consisting of the first time information and the second time information.

Likewise, to solve the above problem, a content update method in a communication terminal according to the present invention includes a content storage step of storing content containing first time information indicating a specified time unit of information representing a time, a terminal information storage step of storing terminal information containing second time information indicating a time unit shorter than the specified time unit and assigned to each communication terminal, a time determination step of determining whether it has reached a time consisting of the first time information and the second time information, and a content update step of performing a content update process when the time determination means determines that it has reached a time consisting of the first time information and the second time information.

According to the present invention, content containing first time information indicating a specified time unit of information representing a time is stored, and, using the first time information, it is determined that it has reached a time to perform a content update process. It is thereby possible to update content at the optimum time period according to the type of content. Further, second time information stored in the terminal information storage means is assigned to each communication terminal. Thus, the content update process is not performed at the same time among many terminals, and a load on a network or a content delivery server is reduced.

Further, the communication terminal according to the present invention may further include a communication state determination means for determining whether the communication terminal is in a communication-enabled state, a random number generation means for generating random numbers, and a waiting time decision means for deciding a waiting time within a specified length of time based on the random numbers generated by the random number generation means, and, in a case where the communication state determination means determines that the communication terminal is in a communication-disabled state when the time determination means determines that it has reached a time consisting of the first time information and the second time information, the content update means may perform the content update process upon lapse of the waiting time decided by the waiting time decision means after the communication terminal returns to the communication-enabled state.

According to the present invention, a waiting time is decided within a specified length of time based on random numbers, and, the content update process is performed upon lapse of the waiting time after the communication terminal returns to the communication-enabled state. It is thereby possible to avoid that a large number of communication terminals perform the content update process at the same time, imposing a load on a network and a content delivery server. It is also possible to perform the content update process without waiting for a time consisting of the first time information and the second time information.

Further, the communication terminal according to the present invention may further include a communication restriction determination means, and, in a case where the communication restriction determination means determines that the communication terminal is under communication restriction when the time determination means determines that it has reached a time consisting of the first time information and the second time information, the content update means may perform the content update process upon reaching a time indicated by the second time information after the communication restriction is disabled.

According to the present invention, the content update process is performed upon reaching a time indicated by the second time information after the communication restriction is disabled. Thus, the content update process in each communication terminal after the communication restriction is disabled is performed at the time distributed within the range of a time unit indicated by the first time information. This reduces a load on a network or a content delivery server that is caused by the concentrated occurrence of the update process after the communication restriction is disabled.

### Advantageous Effects of Invention

According to the present invention, it is possible to update content at the optimum time according to the type of content.

### BRIEF DESCRIPTION OF DRAWINGS

FIG. 1 is a diagram showing a functional configuration of a communication terminal according to an embodiment.

FIG. 2 is a diagram showing a hardware configuration of the communication terminal according to the embodiment.

FIG. 3 is a diagram showing an example of a configuration file for setting a time period to update content.

FIG. 4 is a flowchart showing a content update process by the communication terminal according to the embodiment.

### DESCRIPTION OF EMBODIMENTS

A preferred embodiment of a communication terminal and a content update method according to the present invention are described hereinafter with reference to the appended drawings. Note that, in the description of the drawings, the same elements are denoted by the same reference numerals, and repeated explanation thereof is omitted.

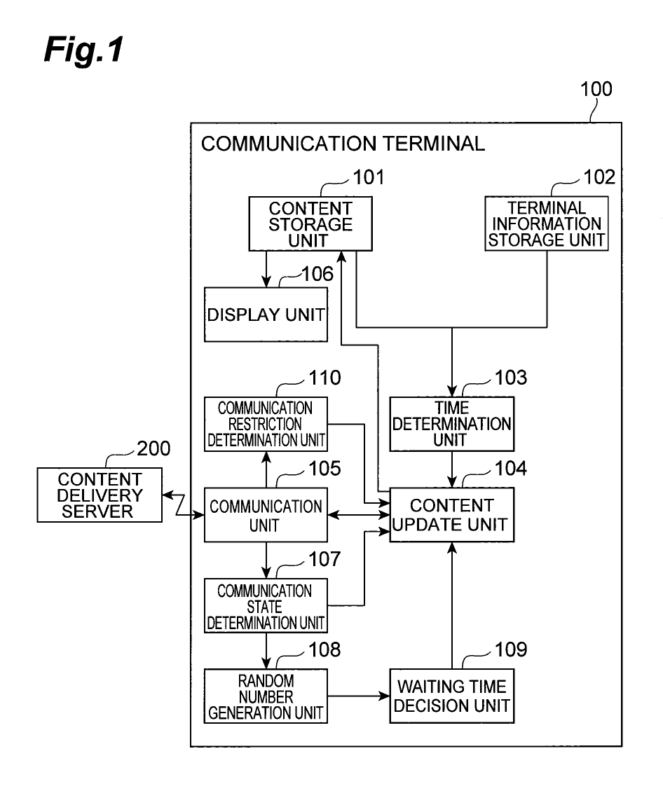

FIG. 1 shows a functional configuration of a communication terminal according to an embodiment. A communication terminal 100 according to this embodiment includes a content storage unit 101 (content storage means), a terminal information storage unit 102 (terminal information storage means), a time determination unit 103 (time determination means), a content update unit 104 (content update means), a communication unit 105, a display unit 106, a communication state determination unit 107 (communication state determination means), a random number generation unit 108 (random number generation means), a waiting time decision unit 109 (waiting time decision means), and a communication restriction determination unit 110 (communication restriction determination means).

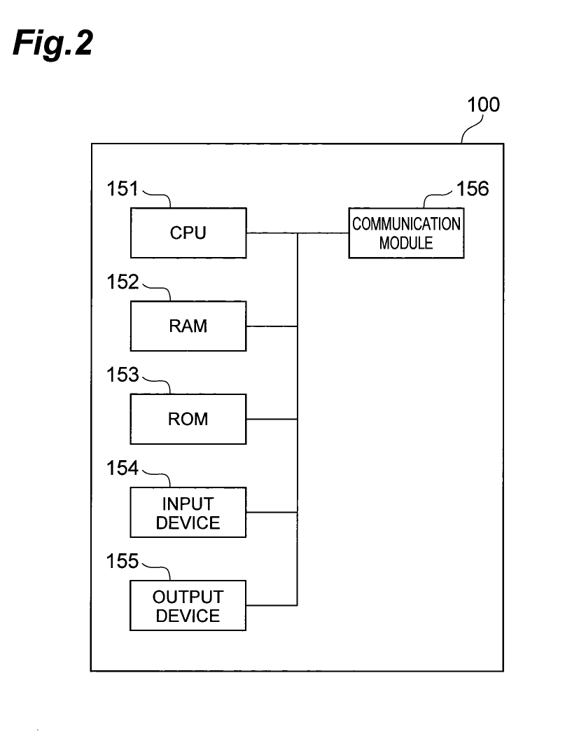

FIG. 2 shows a hardware configuration of the communication terminal 100. The communication terminal 100 is physically composed of a CPU 151, a RAM 152, a ROM 153, an input device 154, an output device 155, and a communication module 156. The functions of the communication terminal 100 shown in FIG. 1 are implemented by loading given computer software onto hardware such as the RAM 152 or the like shown in FIG. 2, making the communication module 156, the input device 154 and the output device 155 operate under control of the CPU 151, and performing data reading in the RAM 152 and the ROM 153 and data writing in the RAM 152. Each functional block is described hereinafter with reference to the functional blocks shown in FIG. 1.

The content storage unit 101 stores content delivered from a content delivery server 200. Content is information that can be displayed on a screen of the communication terminal 100. Content contains hour information indicating the longest time unit of information representing a time as first time information. In this embodiment, the length of a time period indicated by the hour information is one hour.

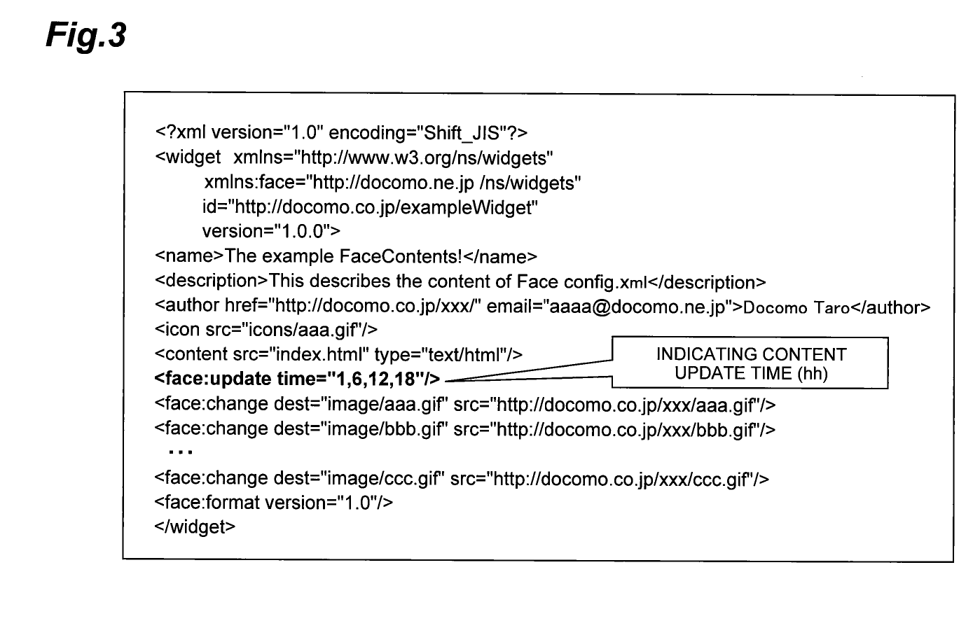

FIG. 3 shows a specific example of a file stored in the content storage unit 101. The row “<face:update time=“1,6,12,18”>” in the file indicates the time period of 1:00 to 1:59, 6:00 to 6:59, 12:00 to 12:59 and 18:00 to 18:59.

The terminal information storage unit 102 stores terminal information that is unique to a communication terminal. The terminal information contains minute information indicating a minute, which is a shorter time unit than the time unit indicated by the first time information, as second time information. As the minute information, values of 0 to 59 minutes are sequentially assigned to communication terminals at the time of factory shipment of the communication terminal. For example, the minute information for performing the update of content is assigned to each communication terminal, such as 0 minute specified for a certain communication terminal, one minute for another communication terminal, and two minutes for yet another communication terminal. Further, when a value that is assigned to a communication terminal reaches 59 minutes, values are sequentially assigned from 0 minute again. As a result, the minute information is assigned to each terminal without concentrating on a specific time. Note that users of communication terminals cannot change the minute information.

The time determination unit 103 determines whether it has reached a time consisting of the hour information stored in the content storage unit 101 and the minute information stored in the terminal information storage unit 102. For example, consider the case where the hour information indicating “3 o'clock” is stored in the content storage unit 101, and the minute information indicating “15 minutes” is stored in the terminal information storage unit 102. In this case, the time determination unit 103 determines whether it has reached the time “3:15” that consists of the information “3 o'clock” stored in the content storage unit 101 and the information “15 minutes” stored in the terminal information storage unit 102.

The content update unit 104 performs a content update process when the time determination unit 103 determines that it has reached a time consisting of the hour information stored in the content storage unit 101 and the minute information stored in the terminal information storage unit 102. The content update process is specifically performed as follows. First, the content update unit 104 requests the communication unit 105 to download content data. Next, the communication unit 105 downloads content data from the content delivery server 200. Then, the content update unit 104 rewrites data of the content storage unit 101 using the data downloaded by the communication unit 105.

The communication unit 105 requests the content delivery server 200 to transmit data to update content when the content update unit 104 performs the content update process. Further, the communication unit 105 receives data transmitted from the content delivery server 200 and stores the data into the content storage unit 101.

The display unit 106 displays content stored in the content storage unit 101. Thus, when the content update unit 104 updates the data of the content storage unit 101, the content displayed on the display unit 106 is updated accordingly. Note that the updated content may be always displayed or may be non-displayed and held in active state so that it can be displayed immediately in response to a user's screen change operation, read operation or the like.

The communication state determination unit 107 determines whether the communication terminal 100 is in a communication-enabled state using the communication unit 105.

The random number generation unit 108 generates random numbers. The waiting time decision unit 109 randomly decides the waiting time within the range of a specified length of time that is shorter than the time unit indicated by the first time information based on the random numbers generated by the random number generation unit 108. In this embodiment, the waiting time decision unit 109 decides the waiting time within the range of 10 minutes.

The communication restriction determination unit 110 determines whether the communication terminal 100 is under restriction of communication using the communication unit 105.

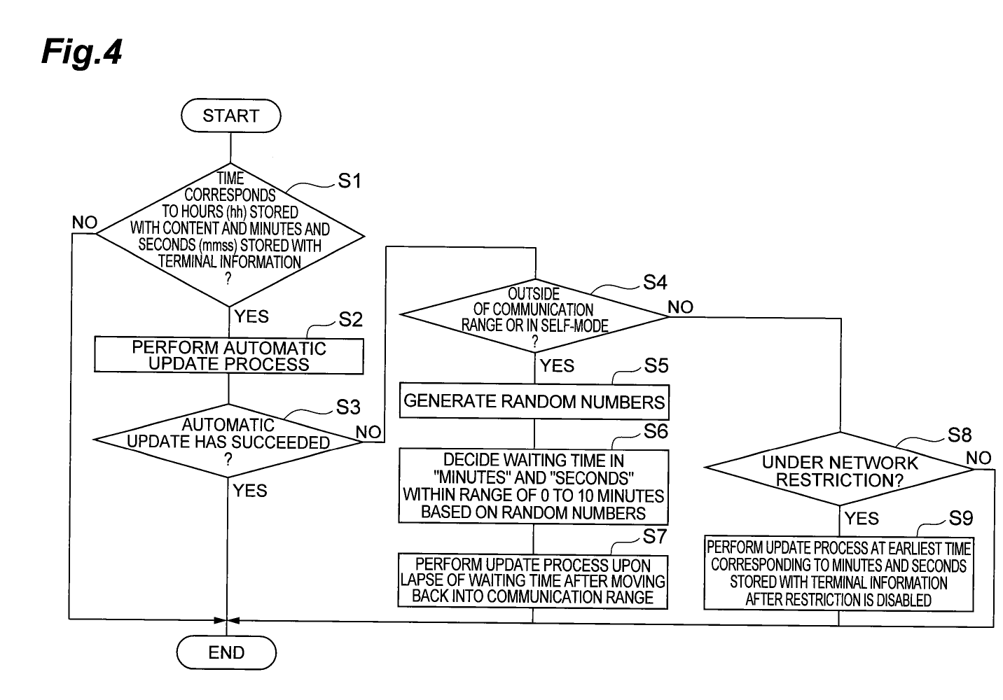

A process of the communication terminal 100 according to this embodiment is described hereinafter with reference to the flowchart of FIG. 4. FIG. 4 shows the flow of the process of the communication terminal 100 according to this embodiment. The process shown in FIG. 4 is executed repeatedly at regular intervals, i.e. every one minute. Note that the process shown in FIG. 4 is carried out on condition that a content storage step that stores content containing hour information indicating a time period and a terminal information storage step that stores terminal information containing minute information indicating a minute are already carried out.

First, the time determination unit 103 determines whether it has reached a time consisting of the hour information stored in the content storage unit 101 and the minute information stored in the terminal information storage unit 102 (Step S1: time determination step). When it is determined that it has not reached such a time (NO in Step S1), the process ends. On the other hand, when it is determined that it has reached such a time (YES in Step S1), the content update unit 104 performs an automatic update process (Step S2: content update step).

Next, the content update unit 104 determines whether the automatic update process has succeeded or not (Step S3: automatic update success/failure determination step). When it is determined that the automatic update process has succeeded (YES in Step S3), the process ends. On the other hand, when it is determined that the automatic update process has failed (NO in Step S3), the communication state determination unit 107 determines whether the communication terminal 100 is outside of communication range or in self-mode (Step S4: communication state determination step). Specifically, it is determined whether the communication terminal 100 is in a communication-disabled state or not. Note that the self-mode is mode in which the communication terminal does not transmit or receive a radio wave.

When it is determined that the communication terminal 100 is outside of communication range or in self-mode (YES in Step S4), the random number generation unit 108 performs a random number generation process (Step S5). In this case, the waiting time decision unit 109 then decides the waiting time within the range of 0 to 10 minutes based on the random numbers generated by the random number generation unit 108 (Step S6). Then, after the communication terminal 100 moves back into communication range, upon the lapse of the waiting time, the content update unit 104 performs an update process (Step S7). Note that in the case where it has reached a time consisting of the hour information stored in the content storage unit 101 and the minute information stored in the terminal information storage unit 102 before the lapse of the waiting time, the content update unit 104 may perform the content update process at the time consisting of the hour information and the minute information and not perform the content update process upon the lapse of the waiting time.

On the other hand, when it is determined that the communication terminal 100 is not outside of communication range and not in self-mode (NO in Step S4), the communication restriction determination unit 110 determines whether network restriction is enabled or not (Step S8: network restriction determination step). When it is determined that network restriction is enabled (YES in Step S9), after network restriction is disabled, the content update unit 104 performs an update process at the earliest time that corresponds to the minute information stored together with the terminal information (Step S9). On the other hand, when it is determined that network restriction is not enabled (NO in Step S9), the process ends without performing an update process.

As described above, the communication terminal 100 according to this embodiment determines, using the time determination unit 103, whether it has reached a time consisting of the hour information stored in the content storage unit 101 and the minute information stored in the terminal information storage unit 102, and when it has reached such a time, performs a content update process. Therefore, it is possible to update content at the optimum time for each type of content. Further, the minute information stored in the terminal information storage unit 102 is assigned to be different for each communication terminal. It is thus possible to prevent the minute information from being unevenly assigned among many terminals and thereby avoid that the update process occurs excessively at the same time, imposing a load on a network or a server.

Further, the communication terminal 100 according to this embodiment includes the random number generation unit 108 and the waiting time decision unit 109 that decides the waiting time within the range of 0 to 10 minutes based on random numbers generated by the random number generation unit 108, and, in the case where the communication state determination unit 107 determines that the communication terminal 100 is in the communication-disabled state when it has reached a time consisting of the time information and the minute information, the content update unit 104 performs the update process upon the lapse of the waiting time after the communication terminal 100 returns to the communication-enabled state. Therefore, the update process can be performed without waiting for a time consisting of the hour information stored in the content storage unit 101 and the minute information stored in the terminal information storage unit 102 after the communication terminal 100 returns to the communication-enabled state.

Furthermore, in the communication terminal 100 according to this embodiment, in the case where the communication restriction determination unit 110 determines that the communication terminal 100 is under communication restriction when the time determination unit 103 determines that it has reached a time consisting of the hour information stored in the content storage unit 101 and the minute information stored in the terminal information storage unit 102, the content update unit 104 performs the content update process upon reaching a time indicated by the minute information after communication restriction is disabled. Therefore, after communication restriction is disabled, the update process is distributed among the respective terminals over a relatively long period of time: one hour. A load imposed on a network or a server is thereby reduced.

While the communication terminal 100 according to this embodiment and the content update method using the communication terminal 100 are described above with reference to a preferred embodiment, the present invention is not limited to the above-described embodiment.

For example, in the above-described embodiment, a time indicated by the second time information that is stored in the terminal information storage unit 102 is in minutes. However, as the second time information, seconds may be specified in addition to minutes, or only seconds may be specified instead of minutes.

Further, for example, a time indicated by the first time information that is stored in the content storage unit 101 may be a time unit longer than one hour or a time unit shorter than one hour. In this case, a time indicated by the second time information that is stored in the terminal information storage unit 102 is assigned within the range of a time unit indicated by the first time information. Further, a time indicated by the first time information may be in minutes, and a time indicated by the second time information may be in seconds.

Further, in the above-described embodiment, the minute information is assigned to each terminal at the time of factory shipment. However, the minute information may be generated at random at the first start of a communication terminal, without assigning the minute information to the communication terminal at the time of factory shipment.

Further, in the flowchart of FIG. 4, the determination as to whether the automatic update process has succeeded or not is made in Step S3 and, when it is determined that the automatic update process has not succeeded, the determination as to whether it is outside of communication range or in self-mode is made in Step S4, and when it is determined that it is not outside of communication range and not in self-mode, the determination as to whether network restriction is enabled or not is made in Step S8. However, the determination in Step S4 may be skipped, and the determination as to whether network restriction is enabled or not in Step S8 may be made when it is determined that the automatic update process has not succeeded in Step S3.

### REFERENCE SIGNS LIST

100 . . . communication terminal, 101 . . . content storage unit (content storage means), 102 . . . terminal information storage unit (terminal information storage means), 103 . . . time determination unit (time determination means), 104 . . . content update unit (content update means), 105 . . . communication unit, 106 . . . display unit, 107 . . . communication state determination unit (communication state determination means), 108 . . . random number generation unit (random number generation means), 109 . . . waiting time decision unit (waiting time decision means), 110 . . . communication restriction determination unit (communication restriction determination means), 200 . . . content delivery server

1. A communication terminal comprising:
a content storage means for storing content containing first time information indicating a specified time unit of information representing a time;
a terminal information storage means for storing terminal information containing second time information indicating a time unit shorter than the specified time unit and assigned to each communication terminal;
a time determination means for determining whether it has reached a time consisting of the first time information and the second time information; and
a content update means for performing a content update process when the time determination means determines that it has reached a time consisting of the first time information and the second time information.

2. The communication terminal according to claim 1, further comprising:
a communication state determination means for determining whether the communication terminal is in a communication-enabled state;
a random number generation means for generating random numbers; and
a waiting time decision means for deciding a waiting time within a specified length of time based on the random numbers generated by the random number generation means,
wherein, in a case where the communication state determination means determines that the communication terminal is in a communication-disabled state when the time determination means determines that it has reached a time consisting of the first time information and the second time information, the content update means performs the content update process upon lapse of the waiting time decided by the waiting time decision means after the communication terminal returns to the communication-enabled state.

3. The communication terminal according to claim 1, further comprising:
a communication restriction determination means,
wherein, in a case where the communication restriction determination means determines that the communication terminal is under communication restriction when the time determination means determines that it has reached a time consisting of the first time information and the second time information, the content update means performs the content update process upon reaching a time indicated by the second time information after the communication restriction is disabled.

4. A content update method in a communication terminal, comprising:
a content storage step of storing content containing first time information indicating a specified time unit of information representing a time;
a terminal information storage step of storing terminal information containing second time information indicating a time unit shorter than the specified time unit and assigned to each communication terminal;
a time determination step of determining whether it has reached a time consisting of the first time information and the second time information; and
a content update step of performing a content update process when the time determination means determines that it has reached a time consisting of the first time information and the second time information.

5. The communication terminal according to claim 2, further comprising:
a communication restriction determination means,
wherein, in a case where the communication restriction determination means determines that the communication terminal is under communication restriction when the time determination means determines that it has reached a time consisting of the first time information and the second time information, the content update means performs the content update process upon reaching a time indicated by the second time information after the communication restriction is disabled.
